(19) United States
(12) Patent Application Publication
(10) Pub. No.: US 2024/0198887 A1
(43) Pub. Date: Jun. 20, 2024

(54) STORABLE FIXTURE ASSEMBLIES FOR RECREATIONAL VEHICLES

(71) Applicant: MORRYDE INTERNATIONAL, INC., Elkhart, IN (US)

(72) Inventors: Jon Kauffman, Elkhart, IN (US); Darrell Byers, Topeka, IN (US)

(21) Appl. No.: 18/542,657

(22) Filed: Dec. 16, 2023

Related U.S. Application Data
(60) Provisional application No. 63/433,182, filed on Dec. 16, 2022.

(51) Int. Cl. B60P 3/34; B60P 3/36

(52) U.S. Cl. CPC B60P 3/34; B60P 3/36

(57) ABSTRACT

Assemblies for recreational vehicles include a fixture that is configured to be pivotably coupled relative to the recreational vehicle, such that the fixture is pivotable between a vertically-oriented storage position in a space within an exterior perimeter of the recreational vehicle and a horizontally-oriented use position disposed at least partially outside of the space and extending away from the exterior perimeter of the recreational vehicle. The assemblies further include a support that is movable relative to the recreational vehicle to be moved to a support position supporting the fixture in the use position

This application claims the priority benefit of U.S. Provisional Application No. 63/433,182, filed Dec. 16, 2022, which is hereby incorporated by reference herein in its entirety.

### FIELD OF THE DISCLOSURE

The present disclosure generally relates to storable fixtures for recreational vehicles.

### BACKGROUND

Recreational vehicles include a frame that provides support for a floor of the vehicle, as well as various structural connections for wheel assemblies and so forth. Given the size of many recreational vehicles and the ground clearance needed for operation, the frame of these vehicles would be undesirably visible from many vantage points. Accordingly, recreational vehicles typically include a skirt of material that depends downwardly around the exterior of the vehicle to hide the vehicle's frame.

### SUMMARY

In accordance with a first aspect, a storable fixture assembly for a recreational vehicle is disclosed that includes a fixture comprising a body and a working surface. The fixture is configured to be pivotably coupled relative to the recreational vehicle to be pivotable between a vertically-oriented storage position in a space within an exterior perimeter of the recreational vehicle and a horizontally-oriented use position disposed at least partially outside of the space and extending away from the exterior perimeter of the recreational vehicle. The assembly further includes a support that is movable relative to the recreational vehicle to be moved to a support position supporting the fixture in the use position.

In some examples, the assembly can include a housing that is configured to be mounted within the space, where the housing has a forwardly facing opening and includes a plurality of walls defining an interior. In these examples, the fixture and support can be pivotably coupled to the housing, e.g., the fixture can be pivotably coupled to a top wall of the plurality of walls of the housing to hang downwardly from the top wall in the storage portion and the support can be pivotably coupled to a bottom wall of the plurality of walls of the housing. In further examples, the housing can include a door coupled to the housing that is movable to selectively cover the opening thereof.

In some examples, the assembly can include a frame that includes a stationary portion mounted to the housing and a pivoting portion pivotably coupled to the stationary portion, where the fixture is mounted to the pivoting portion to be pivoted therewith. In further examples, the pivoting portion can include a sliding coupling that allows the fixture to be slid outwardly to an extended use position spaced from the exterior perimeter of the recreational vehicle. If desired, the sliding coupling can include a catch to hold the fixture in the extended position. In further examples, the pivoting portion can include one or more hooks configured to receive a portion of the support therein to hold the support in the support position.

In some examples, the assembly can include a hydraulic cylinder coupled to the fixture that is configured to aid a user in pivoting the fixture from the storage position to the use position. In further examples, the hydraulic cylinder can be configured to be driven over center as the fixture is pivoted to the storage position, such that the hydraulic cylinder aids in holding the fixture in the storage position.

In any of the above examples, the fixture can include a cooking appliance and the working surface can include a cooking surface. In further examples, the cooking appliance can include a gas burning element and a gas intake connector fluidly coupled to the gas burning element, where the gas intake connector is configured to have a gas supply line coupled thereto and disposed on the cooking appliance, such that the cooking appliance is prevented from being pivoted to the storage position with the gas supply line coupled to the gas intake connector.

In any of the above examples, the fixture can include a sink. The sink may have a water intake connector configured to have a water supply line coupled thereto or can be a basin with or without a drain without a separate water supply. The sink may include a stopper or plug mechanism for the drain to retain water in the basin.

In any of the above examples, the assembly can include one or more trays configured to releasably attach to the cooking appliance to provide working surfaces adjacent thereto

In accordance with a second aspect, a recreational vehicle is disclosed that includes a frame and an exterior including a downwardly depending skirt portion spaced from the frame by a space. The recreational vehicle further includes the assembly of any of the above examples, where the assembly is mounted to the frame at least partially within the space between the frame and the skirt portion.

In accordance with a third aspect, a method is disclosed that includes pivoting a fixture from a vertically-oriented storage position in a space within an exterior perimeter of a recreational vehicle to a horizontally-oriented use position disposed at least partially outside of the space and extending away from the exterior perimeter of the recreational vehicle and coupling a support with the fixture to hold the fixture in the use position.

In some examples, the method can include one or more of the following aspects: pivoting the fixture from the storage position to the use position can include pivoting the fixture about a pivot disposed above the fixture in the storage position; coupling the support with the fixture can include pivoting the support to a support position and securing the support to a frame having the fixture mounted thereto to hold the support in the support position; the method can include sliding the fixture outward from the use position to an extended use position using a sliding coupling, which can optionally include securing the fixture in the extended use position; the fixture can include a sink and the method can include connecting a gas supply line to a gas intake connector of the cooking appliance; and/or the fixture can include a sink and the method can include connecting a water supply line to a water intake connector of the sink.

### BRIEF DESCRIPTION OF THE DRAWINGS

FIG. 1 is a diagrammatic side view of an example recreational vehicle in accordance with the teachings of the present disclosure.

FIG. 2 is a top front perspective view of an assembly including a first example fixture with a cooking appliance in a storage position in accordance with the teachings of the present disclosure.

FIG. 3 is a top rear perspective view of the assembly of FIG. 2 with the fixture in the storage position.

FIG. 4 is a top front perspective view of the assembly of FIG. 2 including an outer housing with the fixture in the storage position.

FIG. 5 is a top front perspective view of the assembly of FIG. 2 with the fixture in a use position.

FIG. 6 is a bottom front perspective view of the assembly of FIG. 2 including the outer housing with the fixture in the use position.

FIG. 7 is a bottom front perspective view of the assembly of FIG. 2 including the outer housing with the fixture in an extended use position.

FIG. 8 is a top front perspective view of the assembly of FIG. 2 including the outer housing and removable trays with the fixture in the extended use position.

FIG. 9 is a top front perspective view of an example sliding coupling for the cooking appliance assembly of FIG. 2.

FIG. 10 is a top front perspective view of an assembly including a second example fixture with a sink and countertop/cutting board with the fixture in a use position in accordance with the teachings of the present disclosure.

### DETAILED DESCRIPTION

A fixture assembly is provided that can be stored within a space or recess between an exterior of a recreational vehicle and a frame thereof. For example, the assembly can utilize unused space behind a skirt of the recreational vehicle to provide added function without taking up any of the limited storage or living space within the recreational vehicle. The fixture can be pivotably coupled to the recreational vehicle, such that the fixture can be stored in a vertical orientation and pivoted to a horizontal orientation for use. In some instances, the assembly can be further configured to slide the fixture away from the recreational vehicle to provide clearance therefrom during use. The fixture can be any suitable structure or device. For example, the fixture can be or can include a cooking appliance, a sink, a working surface, such as a counter, cutting board, etc., and so forth.

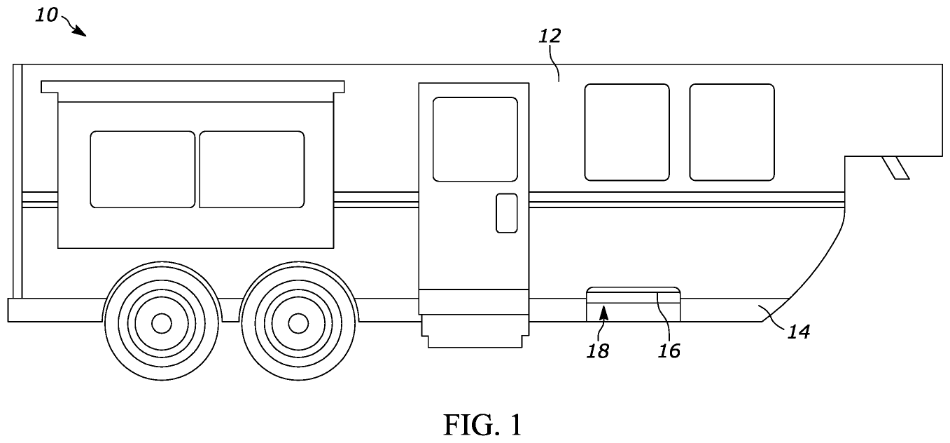

“Recreational vehicles” or “RVs” as described herein are intended to include toy haulers, travel trailers, fifth wheels, goosenecks, motor homes, campers, and so forth. The RV can be a towable trailer or a motorized unit. An example RV 10 is shown in FIG. 1 that has an exterior 12 formed at least partially from sheets or members made from a suitable material, e.g., metal and/or plastic, including a bottom skirt portion 14 that depends downwardly from a floor of the RV 10 (not shown) to hide the RV's frame 16 among other uses. As shown, the skirt portion 14 is spaced from the frame 16 by a space or recess 18.

An assembly 100 as provided herein can advantageously be mounted within the space 18 to utilize the otherwise unused space. The assembly 100 includes a fixture 102 movable from the space 18 for use. The fixture 102 has a body 105 with a working surface 106 extending over at least a portion of the top of the body 105. The body 105 can be a solid structure or can define an interior to house components of the fixture 102 and/or for storage.

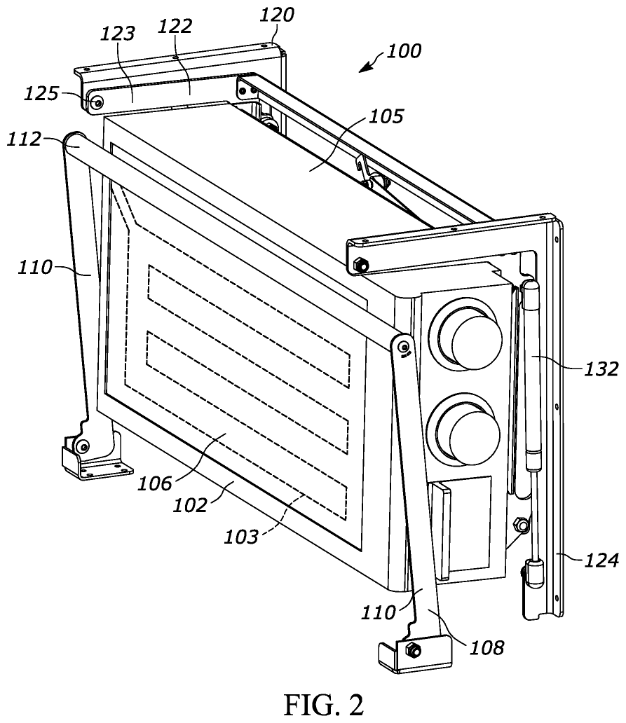

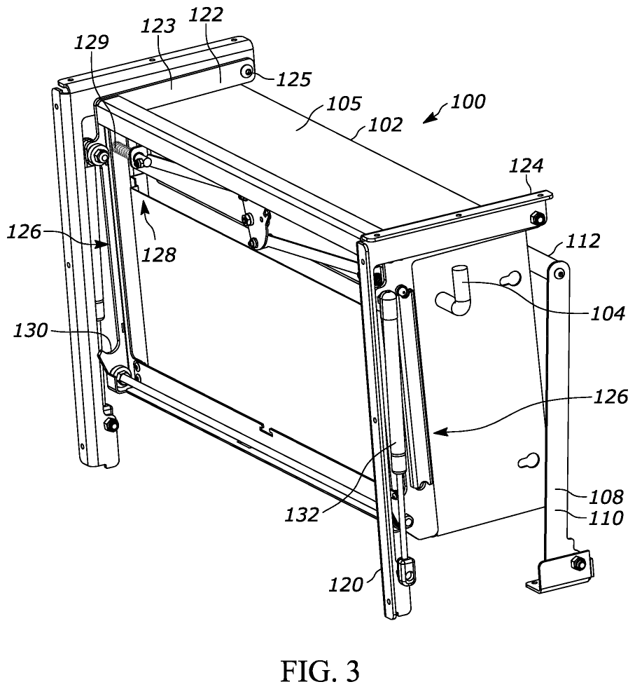

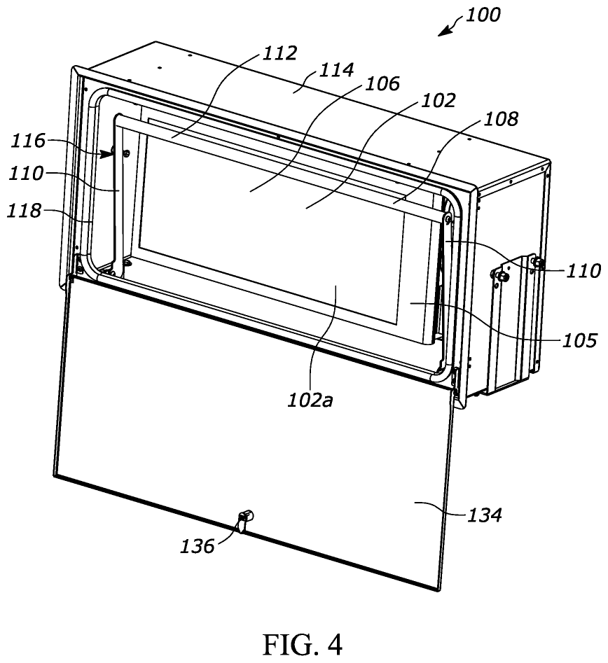

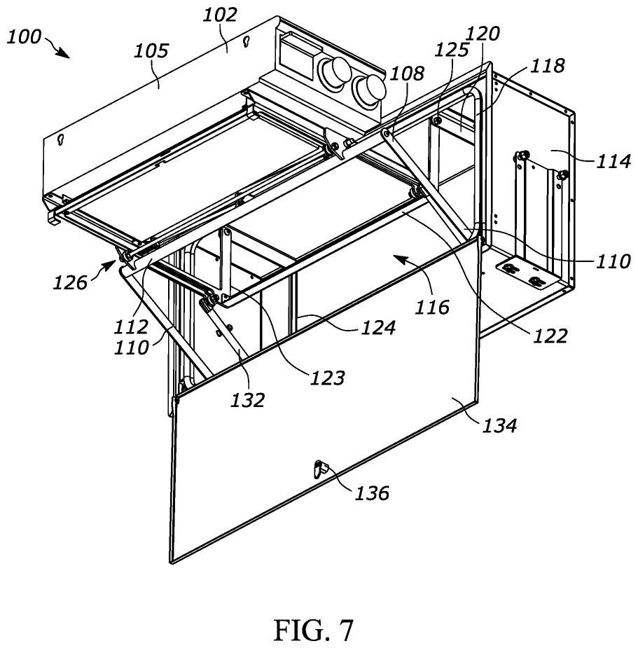

One example assembly 100 is shown in FIGS. 2-9. The fixture 102 of this example includes a cooking appliance 102a, such as a grill, griddle, flat top, burner, combinations thereof, and so forth. Accordingly, the fixture 102 can include a gas-burning element 103 and gas conduits, including a gas intake connector 104 to connect the fixture 102 to a gas supply line, to fluidly connect the gas-burning element 103 to the gas supply line. The gas supply line can be internal to the RV 10 or from a separate source, such as a propane tank or the like. In other or additional examples, the cooking appliance 102a can include an electric, induction, and/or resistance element 103 and electrical connections, including a cord or the like (not shown) to connect the fixture 102 to a power supply. The power supply can be from the RV 10 or from a separate source, such as a battery, generator, or the like. It will be understood that the cooking appliance can include any suitable controls, e.g., temperature controls, gas supply knobs, starters, etc., and valving for desired functionality. With the cooking appliance 102a, the working surface 106 of the fixture 102 includes a cooking surface extending over at least a portion of the top of the body 105. As shown, the gas intake connector 104/cord is accessible on an outside of the body 105.

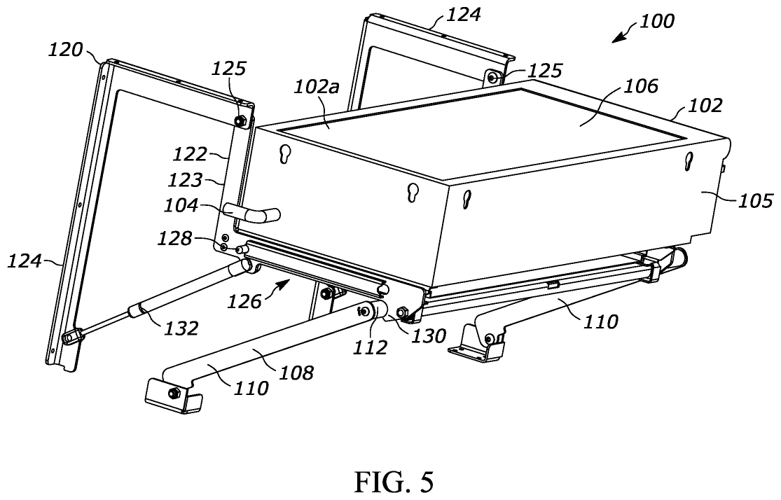

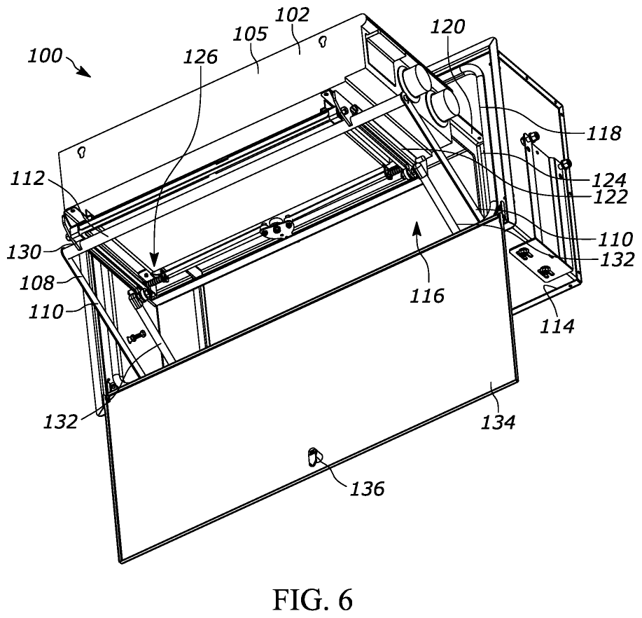

The fixture 102 is pivotably coupled relative to the RV 10 to be pivotable between a generally vertically-oriented storage position and a generally horizontally-oriented use position that orients the working surface 106 to be facing upwardly. As shown, the fixture 102 can be stored within the space 18 of the RV 10 when in the storage position (FIGS. 2-4) and pivoted at least partially outside of the space 18 in the use position (FIGS. 5-6) such that the fixture 102 extends away from the exterior 12 of the RV 10.

It will be understood that generally vertically oriented is intended to include a range of angles relative to vertical, such as between −45 degrees to 45 degrees, −30 degrees to 30 degrees, −15 degrees to 15 degrees, and so forth. In a similar manner, generally horizontally oriented is intended to mean a range of angles relative to horizontal, e.g., −10 degrees to 10 degrees, −5 degrees to 5 degrees, −3 degrees to 3 degrees, −1 degree to 1 degree, and so forth. These orientations can also take into account an orientation of the RV 10, to which the fixture 102 is coupled due to the affect such a coupling will have on resulting orientation.

In some examples, the assembly 100 is configured to prevent the fixture 102 from being pivoted to the storage position when a supply line is coupled to the fixture 102. For example, the assembly 100 can be configured to prevent the fixture 102 from being pivoted to the storage position when a gas supply line is coupled to the gas intake connector 104. In some examples, the gas supply line can be configured to abut a housing of the assembly, discussed in more detail below, the RV 10, or another structure before the fixture 102 is fully pivoted to the storage position.

The assembly 100 includes a support 108 that is configured to be selectively coupled to the fixture 102 after the fixture 102 has been pivoted to the use position to hold the fixture 102 in a horizontal orientation. As shown, the support 108 can be pivotably coupled or otherwise movable relative to the RV 10, such that the support 108 can be pivoted from a storage position within the space 18 to a support position supporting the fixture 102 in the use position. In the illustrated example, the support 108 includes a pair of arm members 110 with a cross-bar 112 extending between distal ends of the arm members 110. Proximal ends of the arms 110 are pivotably coupled relative to the RV 10, such that the distal ends, and the cross-bar 112 beneath the fixture 102.

In some examples, the assembly 100 can further include an outer housing 114 that includes one or more walls defining an interior 116 to receive the fixture 102 and the support 108 therein when stored. The housing 114 has a forwardly facing opening 118 to provide access to the interior 116, through which the fixture 102 can be pivoted. As shown, the fixture 102 and support 108 are pivotably coupled to the housing 114, such that the fixture 102 and support 108 can be pivoted relative to the housing 114 between the positions thereof. For example, the fixture 102 can be pivotably coupled to a top wall and/or side walls of the housing 114 to hang downwardly therefrom when the fixture 102 is in the storage portion. Further, the support 108 can be pivotably coupled to a bottom wall or side walls of the housing 114 to be selectively pivoted beneath the fixture 102. The housing 114 is sized to be mounted to the frame 16 within the space 18 of the RV 10 to position the fixture 102 at a desirable height for use.

By one approach, the assembly 100 can include a frame 120 coupling the fixture 102 to the housing 114. As such, the frame 120 can include a pivoting portion 122 coupled to the fixture 102 and a stationary portion 124 coupled to the housing 114. The pivoting portion 122 can include members welded or otherwise secured, e.g., by fasteners or the like, to the fixture 102. For example, the members can be secured to a bottom of the fixture 102, such as around a perimeter thereof. The pivoting portion 122 can also include L-shaped members 123 having an end pivotably coupled above the fixture 102, a first portion extending downwardly relative to the fixture 102, and a second portion configured to extend below the fixture 102. The stationary portion 124 can be welded or otherwise secured to walls of the housing 114. For example, as shown, the stationary portion 124 can extend from a top wall to a rear wall of the housing 114. The frame 120 includes pivots 125 between the pivoting and stationary portions 122, 124. The pivots 125 can have any suitable form, such as with a pivot member, e.g., pin, bolt, etc., bearings, and so forth.

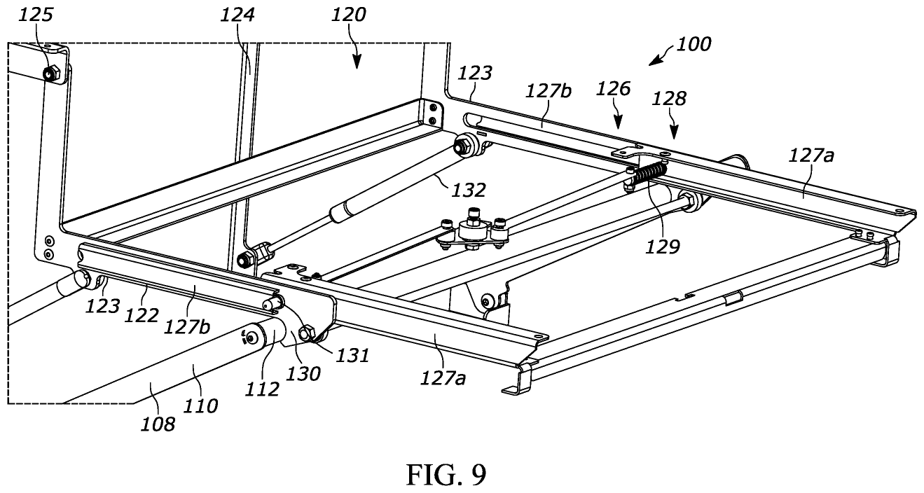

In some instances, it can be helpful to move the fixture 102 further away from the RV 10 to provide additional clearance therefrom during use. Accordingly, as shown in FIG. 9, the pivoting portion 122 of the frame 120 can include rails or other sliding coupling 126 having members 127a,b slidable relative to one another, allowing the fixture 102 to slide outwardly to an extended use position relative to members of the pivoting portion 122 pivotably secured to the stationary portion 124. The sliding coupling 126 can take any suitable form, including rollers, pin-and-slot, tongue-and-groove, bearings, etc.

Additionally, the sliding coupling 126 can include a lock or other catch 128 to hold the fixture 102 in the extended position. The lock 128 can take any suitable form, including a pin and opening, a notch and catch, etc. Additionally, the lock 128 can utilize a biasing mechanism, such as a spring 129, to bias a lock member 131 to a locked position to ensure that the fixture 102 is held in the extended position. In the illustrated example, the lock members 131 extend laterally through openings of an interior member 127a of the sliding coupling 126. The members 131 are biased outwardly to engage the exterior member 127b of the sliding coupling 126. As shown, the exterior member 127b includes engagement portions, e.g., an opening or space, for the lock members 131 to restrict movement of the sliding coupling 126 with the fixture 102 in the use position and the extended position. The engagement portions allow the lock members 131 to extend further outwardly relative to the exterior members 127b to engage the exterior members 127b. To release the lock 128 and move the fixture 102 between the use and extended positions, a user can retract the lock members 131 against the force of the spring 129 from extending through the engagement portions. The exterior members 127b can define a channel to receive the lock members 131 therein when the fixture 102 is moved between the use and extended positions as shown. The lock members 131 can be coupled together with a pivoting retraction control.

The frame 120 can also include a connector 130 as shown in FIGS. 5-7 to engage the support 108 when the support 108 is supporting the fixture 102. The connector 130 can have any suitable form including one or more hooks as shown, a cavity or opening to receive a portion of the support 108 therein, etc. In the illustrated form, the connector 130 includes rearwardly oriented hooks, such that the fixture 102 can be placed onto the support 108 and the support 108 will slide to engage the hooks 130. Advantageously, the weight of the fixture 102 holds the support 108 in engagement with the hooks 130 to ensure that the fixture 102 is fully supported while in use.

The assembly 100 can further include one or more hydraulic cylinders 132 to aid a user in pivoting the fixture 102 between the storage and use positions. Pursuant to this, the hydraulic cylinders 132 can be mounted between the fixture 102 and the housing 114/RV 10. For example, the hydraulic cylinders 132 can have one end mounted to the pivoting portion 122 the frame 120 and the opposite end mounted to the stationary portion 124 of the frame 120.

If desired, the hydraulic cylinders 132 can be mounted relative to the housing 114 and fixture 102, such that the hydraulic cylinders 132 are driven over center as the fixture 102 is pivoted to the storage position. With this configuration, the hydraulic cylinders 132 then begin to extend back outwardly, which acts to maintain the fixture 102 in the storage position and help prevent or reduce pivoting of the fixture 102 when in the storage position.

The assembly 100 can also include a door 134 pivotably coupled to the housing 114 to selectively cover the opening 118 or provide access to the interior 116 thereof. As shown, the door 134 can be pivotably coupled to the housing 114 below the opening 118, such that the door 134 can hang downwardly when open. This allows the door 134 to hang out of the way when the fixture 102 is in the use position. The door 134 and/or housing 114 can include a lock 136 to secure the door 134 in a closed position and prevent access to the housing interior 116.

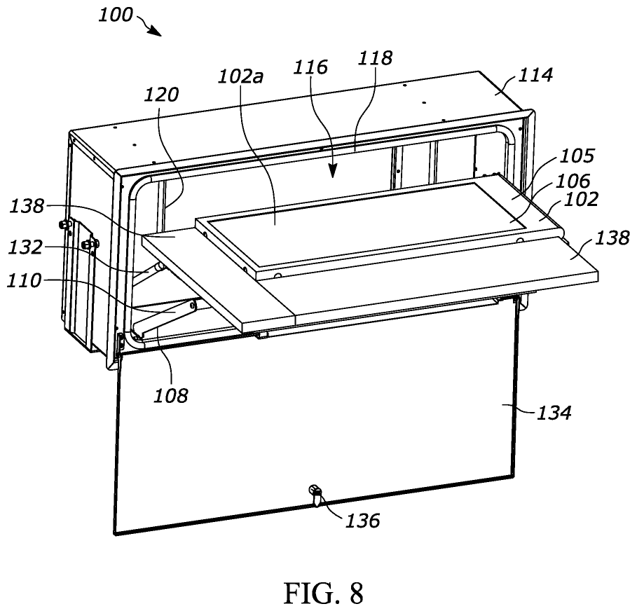

In some example, as shown in FIG. 8, the assembly 100 can be provided with one or more trays 138 that are configured to releasably attach to the body 105 of the fixture 102 with the fixture 102 in the use and/or extended use positions to provide working surfaces around the fixture 102. The trays 138 can attach to the fixture 102 by any suitable connection, including a keyhole and connector, a snap-fit, tongue-and-groove, fasteners, and so forth.

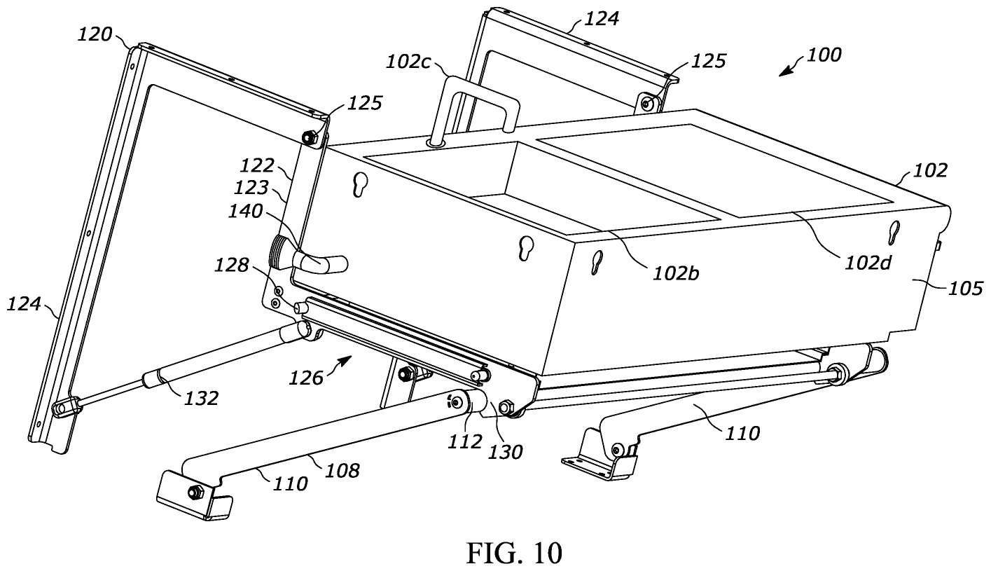

Another example assembly 100 is shown in FIG. 10. The fixture 102 of this example includes a sink 102b. In one implementation, the sink 102b can be a basin that holds liquid. If desired, the sink 102b can include a drain and, optionally, can include a stopper or plug for the drain. In another implementation, the sink 102b can also include a faucet 102c. Accordingly, the fixture 102 can include a water intake connector 140 to connect the fixture 102 to a water supply line to fluidly connect the faucet 102c to the water supply line. The water supply line can be internal to the RV 10 or from a separate source, such as a separate spigot/water source, water tank or the like. With the sink 102b, the working surface 106 of the fixture 102 includes a washing/sink surface extending over or recessed with respect to at least a portion of the top of the body 105. As shown, the water intake connector 140 is accessible on the outside of the body 105. The fixture 102 also includes a countertop and/or cutting board 102d providing a flat area of the working surface 106. It will be understood that the fixture 102 can include one or more of the cooking appliance 102a, the sink 102b, or the countertop/cutting board 102d, and other structures or devices, whether alone, combined with one another, or in combination with one or more of the cooking appliance 102a, the sink 102b, or the countertop/cutting board 102d.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The terms “substantially,” “approximately,” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A storable fixture assembly for a recreational vehicle, the assembly comprising:
a fixture comprising a body and a working surface, the fixture configured to be pivotably coupled relative to the recreational vehicle to be pivotable between a vertically-oriented storage position in a space within an exterior perimeter of the recreational vehicle and a horizontally-oriented use position disposed at least partially outside of the space and extending away from the exterior perimeter of the recreational vehicle; and
a support movable relative to the recreational vehicle to be moved to a support position supporting the fixture in the use position.

2. The assembly of claim 1, further comprising a housing configured to be mounted within the space, the housing having a forwardly facing opening and comprising a plurality of walls defining an interior, wherein the cooking appliance and support are pivotably coupled to the housing.

3. The assembly of claim 2, wherein the fixture is pivotably coupled to a top wall of the plurality of walls of the housing to hang downwardly from the top wall in the storage portion, and the support is pivotably coupled to a bottom wall of the plurality of walls of the housing.

4. The assembly of claim 2, wherein the housing further comprises a door coupled to the housing, the door movable to selectively cover the opening thereof.

5. The assembly of claim 4, wherein the door is pivotably coupled to the housing below the opening.

6. The assembly of claim 1, further comprising a frame including a stationary portion mounted to the housing and a pivoting portion pivotably coupled to the stationary portion, the fixture mounted to the pivoting portion to be pivoted therewith.

7. The assembly of claim 6, wherein the pivoting portion of the frame comprises a sliding coupling, the sliding coupling allowing the fixture to be slid outwardly to an extended use position spaced from the exterior perimeter of the recreational vehicle.

8. The assembly of claim 7, wherein the sliding coupling further comprises a catch to hold the fixture in the extended position.

9. The assembly of claim 6, wherein the pivoting portion of the frame further comprises one or more hooks configured to receive a portion of the support therein to hold the support in the support position.

10. The assembly of claim 1, further comprising a hydraulic cylinder coupled to the fixture, the hydraulic cylinder configured to aid a user in pivoting the fixture from the storage position to the use position.

11. The assembly of claim 10, wherein the hydraulic cylinder is configured to be driven over center as the fixture is pivoted to the storage position, such that the hydraulic cylinder aids in holding the fixture in the storage position.

12. The assembly of claim 1, wherein the fixture comprises a cooking appliance and the working surface comprises a cooking surface.

13. The assembly of claim 12, wherein the cooking appliance comprises a gas burning element and a gas intake connector fluidly coupled to the gas burning element, wherein the gas intake connector is configured to have a gas supply line coupled thereto and disposed on the cooking appliance, such that the cooking appliance is prevented from being pivoted to the storage position with the gas supply line coupled to the gas intake connector.

14. The assembly of claim 1, wherein the fixture comprises a sink.

15. The assembly of claim 1, further comprising one or more trays configured to releasably attach to the fixture to provide secondary working surfaces adjacent thereto.

16. A recreational vehicle comprising:
a frame;
an exterior including a downwardly depending skirt portion spaced from the frame by a space; and
an assembly mounted to the frame at least partially within the space between the frame the skirt portion, the assembly comprising:
a fixture comprising a body and a working surface, the fixture pivotably coupled relative to the recreational vehicle to be pivotable between a vertically-oriented storage position in the space and a horizontally-oriented use position disposed at least partially outside of the space and extending away from the exterior of the recreational vehicle;
a support movable relative to the recreational vehicle to be moved to a support position supporting the fixture in the use position.

17. A method comprising:
pivoting a fixture from a vertically-oriented storage position in a space within an exterior perimeter of a recreational vehicle to a horizontally-oriented use position disposed at least partially outside of the space and extending away from the exterior perimeter of the recreational vehicle; and
coupling a support with the fixture to hold the fixture in the use position.

18. The method of claim 17, wherein pivoting the fixture from the storage position to the use position comprises pivoting the fixture about a pivot disposed above the fixture in the storage position.

19. The method of claim 17, wherein coupling the support with the fixture comprises:
pivoting the support to a support position; and
securing the support to a frame having the fixture mounted thereto to hold the support in the support position.

20. The method of claim 17, further comprising sliding the fixture outward from the use position to an extended use position using a sliding coupling.

21. The method of claim 20, further comprising securing the fixture in the extended use position.

22. The method of claim 17, wherein the fixture comprises a cooking appliance, and further comprising connecting a gas supply line to a gas intake connector of the cooking appliance.

23. The method of claim 17, wherein the fixture comprises a sink, and further comprising connecting a water supply line to a water intake connector of the sink.
